(19) United States
(12) Patent Application Publication
(10) Pub. No.: US 2025/0103945 A1
(43) Pub. Date: Mar. 27, 2025

(54) METHODS AND SYSTEMS FOR FEDERATED LEARNING WITH CLIENT CLUSTERS

(71) Applicants: Zehao ZHANG, Waterloo (CA); Pascal POUPART, Kitchener (CA); Huawei Technologies Canada Co., Ltd., Kanata (CA)

(72) Inventors: Zehao ZHANG, Waterloo (CA); Pascal POUPART, Kitchener (CA); Guojun ZHANG, Montreal (CA); Xi CHEN, Brossard (CA)

(21) Appl. No.: 18/472,182

(22) Filed: Sep. 21, 2023

(51) Int. Cl. G06N 20/00

(52) U.S. Cl. CPC G06N 20/00

(57) ABSTRACT

Methods and systems for federated learning with client clustering are described. A central server conducts rounds of intra-cluster training with two or more clusters to learn, for each cluster, a set of cluster parameters for a respective cluster model. The server merges two clusters into a new merged cluster by communicating, to each client of the two clusters, the cluster parameters of each of the two clusters. The server receives, from each client of the two clusters, performance indicators based on performance of each set of cluster parameters at each client. The central server determines, from the performance indicators, that one of the two clusters should be merged with the other cluster, and defines the new merged cluster to be a union of the two clusters. One set of cluster parameters is selected to be the cluster parameters for the new merged cluster.

### CROSS-REFERENCE TO RELATED APPLICATIONS

This is the first application for this disclosure.

### FIELD

The present disclosure relates to methods and systems for training and deployment of machine learning-based models using federated learning, in particular methods and systems for training and deployment of machine learning-based models for client clusters using federated learning.

### BACKGROUND

The usefulness of artificial intelligence (AI) or machine-learning systems rely on the large amounts of data that are used in the training of a machine learning-based model (sometimes referred to as a predictor) related to a task. There has been interest in how to leverage data from multiple diversified sources, to learn a model related to a task using machine learning.

Federated learning (FL) is a machine learning technique, in which multiple local clients (also referred to as data owners, users, clients or nodes) participate in training of a model (i.e., learning the parameters of a model) related to a task in a collaborative manner without having to share any local data (e.g., data that is local to the client and that may be considered private data). Thus, FL has been of interest as a solution that allows for training a model related to a task using large amounts of local data (which may include user-generated data), such as photos, biometric data, etc., without violating data privacy.

A client participating in FL typically trains a local model and communicates updates of the local model to a central node (e.g., a central server) that aggregates the updates into a global model, which is then communicated back to all participating clients. However, when the local data at different clients have different distributions, a single global model may not be suitable for all clients.

Therefore, it would be useful to provide a solution that may enable different models to be learned for different clients.

### SUMMARY

In various examples, the present disclosure describes methods and systems for FL with client clustering, in which a client may contribute to training of a cluster model.

Examples of the present disclosure may provide the technical advantage that the number of clusters may not be fixed, but rather may be changed during training. This may be advantageous because, in real world implementation, the data distribution among a collection of clients may be unknown, and thus the number of clusters that would better suit the collection of clients may be unknown. Fixing the number of clusters from the start may be based on an incorrect assumption about the data distribution in the clients, which may result in learned models that have worse performance in deployment.

Examples of the present disclosure may also provide the technical advantage that a client may belong to multiple client clusters and may contribute to training of multiple cluster models. This may be advantageous because in some real world scenarios, such as when data is scarce or when there is asymmetry in client benefits (e.g., one client benefits more than another client when a model is collaboratively learned), allowing a client to contribute to multiple clusters may achieve cluster models with better performance. This may also help to ensure fairness in that each client can equally benefit from participating in FL.

The present disclosure describes example embodiments in the context of FL, however it should be understood that disclosed example embodiments may also be adapted for implementation in the context of any distributed optimization or distributed learning systems used to train a model related to a task (e.g., including scenarios where data privacy is not a concern).

In some example aspects, the present disclosure describes a method performed by a server in a federated learning (FL) system, the server being in communication with a plurality of clients of the FL system, two or more clusters, each having at least one client, being defined in the FL system, the method including: conducting rounds of intra-cluster training with the two or more clusters to learn, for each respective cluster of the two or more clusters, a respective set of cluster parameters for a respective cluster model of the respective cluster; merging a first cluster of the two or more clusters with a second cluster of the two or more clusters by: communicating, to each client of the first and second clusters, the respective first and second set of cluster parameters of the first and second clusters; receiving, from each client of the first and second clusters, performance indicators based on performance of each respective first and second set of cluster parameters at each client; determining, from the performance indicators, that at least the first cluster should be merged with the second cluster; defining a new merged cluster to be a union of the first and second clusters, the new merged cluster replacing at least the first cluster defined in the FL system; and selecting one of the respective first and second sets of cluster parameters to be the set of cluster parameters for the new merged cluster; and conducting at least one round of intra-cluster training with the new merged cluster.

In an example of the preceding example method, the method may further include: determining, from the performance indicators, that the second cluster should be merged with the first cluster; and the new merged cluster may also replace the second cluster defined in the FL system

In an example of any of the preceding example methods, the performance indicators received from each client of the first and second clusters may be cluster merge decisions indicating whether or not each client agrees with merging the first and second clusters; and determining that at least the first cluster should be merged with the second cluster may include determining that the cluster merge decisions from all clients of at least the first cluster indicate agreement with merging the first and second clusters.

In an example of some of the preceding example methods, the performance indicators received from each client of the first and second clusters may be validation losses computed by each client for the respective first and second sets of cluster parameters; and determining that at least the first cluster should be merged with the second cluster may include determining that the validation losses computed for the first set of cluster parameters are not statistically better than the validation losses computed for the second set of cluster parameters across all clients of at least the first cluster.

In an example of the preceding example method, the one of the respective first and second sets of cluster parameters selected to be the set of cluster parameters for the new merged cluster may be the set of cluster parameters having better validation losses over a majority of the clients of at least the first cluster.

In an example of any of the preceding example methods, the method may include, prior to conducting the rounds of training: receiving, from the plurality of clients, a respective plurality of cluster definitions defining a respective plurality of clusters, each cluster definition being generated by a respective client and defining a set of one or more clients for a respective cluster; initializing a respective set of cluster parameters for a respective cluster model of each respective cluster; and transmitting each respective set of cluster parameters to the set of one or more clients of the respective cluster.

In an example of the preceding example method, the method may include: prior to the initializing, reducing the clusters by reducing any duplicate cluster definitions.

In an example of any of the preceding example methods, at least one client of the FL system may belong to two or more clusters.

In an example of any of the preceding example methods, the method may include, prior to conducting the rounds of intra-cluster training: partitioning the plurality of clients into client groups; each cluster may be defined to have only clients belonging to a common client group; and the merging may be performed only for merging clusters having clients belonging to the common client group; the method may further include: after completion of the rounds of intra-cluster training, merging at least two clusters having clients belonging to different client groups.

In some example aspects, the present disclosure describes a server in a federated learning (FL) system, the server being in communication with a plurality of clients of the FL system, two or more clusters, each having at least one client, being defined in the FL system, the server including: a memory; and a processing unit in communication with the memory, the processing unit configured to execute instructions in the memory to cause the server to perform any of the preceding example methods.

In some example aspects, the present disclosure describes a non-transitory computer readable medium storing instructions, wherein the instructions, when executed by a processing unit of a server, cause the server to perform any of the preceding example methods.

In some example aspects, the present disclosure describes a method performed by a client in a federated learning (FL) system, the client being one of a plurality of clients of the FL system, the client being in communication with a central server, two or more clusters, each having at least one client, being defined in the FL system, the method including: for each of one or more clusters that the client belongs to, conducting rounds of intra-cluster training to learn, for each respective cluster of the one or more clusters, a respective set of cluster parameters for a respective cluster model of the respective cluster; determining whether to merge at least one current cluster of the one or more clusters with at least one other cluster by: receiving, from the central server, a set of cluster parameters for a cluster model of the at least one current cluster, and a set of cluster parameters for a cluster model of the at least one other cluster; determining a performance indicator based on performance of each set of cluster parameters at the client; and transmitting the performance indicator to the central server, the performance indicator being used by the central server to determine that the at least one current cluster should be merged with the at least one other cluster; receiving, from the central server, a set of cluster parameters for a cluster model of a new merged cluster that is a union of the at least one current cluster and the at least one other cluster; and conducting at least one round of intra-cluster training with the new merged cluster.

In an example of the preceding example method, determining the performance indicator may include: computing a respective validation loss for each of the set of cluster parameters of the at least one current cluster and the set of cluster parameters for the at least one other cluster; and the computed validation losses may be transmitted as the performance indicator to the central server.

In an example of a preceding example method, determining the performance indicator may include: determining performance of each of the set of cluster parameters of the at least one current cluster and the set of cluster parameters for the at least one other cluster at the client; determining that the performance of the set of cluster parameters of the at least one current cluster is not statistically better than the performance of the set of cluster parameters for the at least one other cluster; and determining a cluster merge decision indicating agreement with merging the at least one current cluster and the set of cluster parameters for the at least one other cluster; and the cluster merge decision may be transmitted as the performance indicator to the central server.

In an example of the preceding example method, determining the performance may include: computing a respective validation loss for each of the set of cluster parameters of the at least one current cluster and the set of cluster parameters for the at least one other cluster; and determining that the performance of the set of cluster parameters of the at least one current cluster is not statistically better than the performance of the set of cluster parameters for the at least one other cluster may include determining that the validation loss computed for the set of cluster parameters of the at least one current cluster is not statistically better than the validation loss computed for the set of cluster parameters of the at least one other cluster.

In an example of any of the preceding example methods, the method may include, prior to conducting the rounds of training: training a local model to learn local parameters; receiving a plurality of sets of model parameters, each set of model parameters corresponding to a local model learned by a respective other client of the plurality of clients; comparing performance of the learned local parameters with performance of each received set of model parameters; generating a cluster definition that includes the client as well as each other client having a set of model parameters with equal or better performance compared to the learned local parameters; and transmitting the cluster definition to the central server.

In an example of the preceding example method, the method may include, after transmitting the cluster definition to the central server: receiving from the central server a respective set of initial cluster parameters for each of the one or more clusters that the client belongs to.

In an example of any of the preceding example methods, the client may belong to two or more clusters.

In some example aspects, the present disclosure describes a client computing system in a federated learning (FL) system, the client being one of a plurality of clients of the FL system, the client being in communication with a central server, two or more clusters, each having at least one client, being defined in the FL system, computing system including a memory; and a processing unit in communication with the memory, the processing unit configured to execute instructions to cause the client computing system to perform any of the preceding example methods.

In some example aspects, the present disclosure describes a non-transitory computer readable medium storing instructions, wherein the instructions, when executed by a processing unit of a client computing system, cause the computing system to perform any of the preceding example methods.

### BRIEF DESCRIPTION OF THE DRAWINGS

Reference will now be made, by way of example, to the accompanying drawings which show example embodiments of the present application, and in which:

FIG. 1 is a block diagram of a simplified example system that may be used to implement federated learning, in accordance with examples of the present disclosure;

FIG. 2 is a block diagram of an example computing system that may be used to implement example embodiments described herein, in accordance with examples of the present disclosure;

FIG. 3A is a block diagram illustrating an example implementation of a system for federated learning with client clusters, in an initialization phase, in accordance with examples of the present disclosure;

FIG. 3B is a flowchart of an example method performed by a client of the federated learning system of FIG. 3A, in an initialization phase, in accordance with examples of the present disclosure;

FIG. 3C is a flowchart of an example method performed by a server of the federated learning system of FIG. 3A, in an initialization phase, in accordance with examples of the present disclosure;

FIG. 4A is a block diagram illustrating an example implementation of a system for federated learning with client clusters, in a training phase, in accordance with examples of the present disclosure;

FIG. 4B is a flowchart of an example method performed by a client of the federated learning system of FIG. 4A, in a training phase, in accordance with examples of the present disclosure;

FIG. 4C is a flowchart of an example method performed by a server of the federated learning system of FIG. 4A, in a training phase, in accordance with examples of the present disclosure;

FIG. 5 is a block diagram illustrating an example implementation of the initialization phase and training phase in a simplified federated learning system, in accordance with examples of the present disclosure; and

FIG. 6 is a block diagram illustrating an example implementation of the initialization phase and training phase, with client partitioning, in a simplified federated learning system, in accordance with examples of the present disclosure.

Similar reference numerals may have been used in different figures to denote similar components.

### DETAILED DESCRIPTION

In example embodiments disclosed herein, methods and systems for training a model related to a task (hereinafter referred to as “model”) using federated learning (FL) are described. In particular, methods and systems are described for training cluster models using FL, in which each cluster model is trained using updates from a cluster of clients (rather than all clients participating in FL).

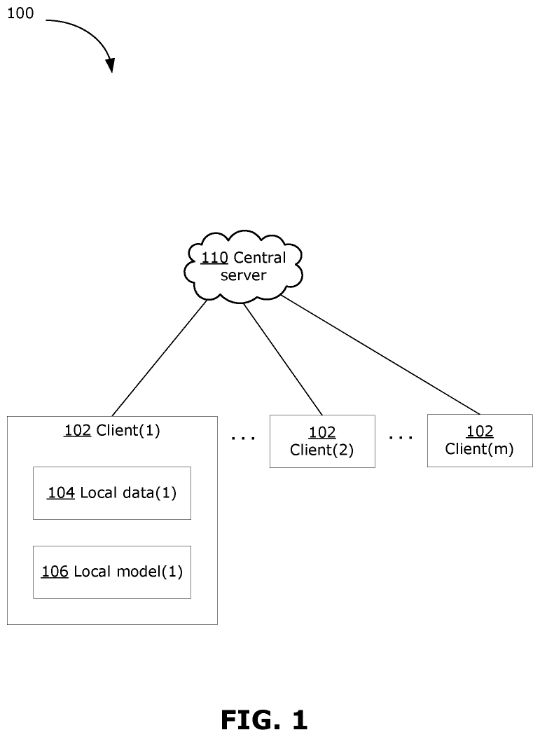

Examples of the present disclosure may enable cluster models to be learned, in which the number of cluster models may be dynamically determined during the rounds of training, and in which a client may contribute to multiple cluster models. In general, a model in the present disclosure may be any type of machine learning model, such as a deep neural network. To assist in understanding the present disclosure, FIG. 1 is first discussed.

FIG. 1 illustrates an example system 100 that may be used to implement examples of FL for learning cluster models, as disclosed herein. The system 100 has been simplified in this example for ease of understanding; generally, there may be more entities and components in the system 100 than that shown in FIG. 1.

The system 100 includes a plurality of clients 102 (client(1) 102 to client(m) 102, generally referred to as client 102), each of which stores or has access to respective sets of local data 104 (also referred to as client data). The local data 104 may be used by the respective client 102 to train a respective local model 106. For example, the local data 104 may be divided into a training set, a validation set and a testing set. Generally, in machine learning, a training set refers to a subset of data that is used to train a machine learning model, a validation set refers to another subset of data that is used to evaluate the performance of the machine learning model during training (e.g., to tune the hyperparameters of the model), and a testing set is another subset of data that is used to evaluate the performance of the trained model (e.g., to estimate the generalization error of the trained model). The training set, validation set and testing set are typically disjoint sets. Details of the local data 104 and local model 106 are shown only for only client 102 (specifically client(1)), however it should be understood that each client 102 may have (or may have access to) its own local data 104 and its own local model 106. It should be understood that clients 102 may alternatively be referred to as user devices, client devices, edge devices, nodes, terminals, consumer devices, or electronic devices, among other possibilities. That is, the term “client” is not intended to limit implementation in a particular type of device or in a particular context.

Each client 102 may independently be an end user device, a network device, a private network, or other singular entity (e.g., mobile device, personal computer, etc.) or plural entity (e.g., a local network of devices at an institution) that is able to generate, collect, store or otherwise access local data 104, and that is able to communicate with the system 100 to participate in FL.

In the case where a client 102 is an end user device or edge device, the client 102 may be or may include such devices as a client device/terminal, user equipment/device (UE), wireless transmit/receive unit (WTRU), mobile station, fixed or mobile subscriber unit, cellular telephone, station (STA), personal digital assistant (PDA), smartphone, laptop, computer, tablet, wireless sensor, wearable device, smart device, machine type communications device, smart (or connected) vehicle, Internet of Things (IoT) device, or consumer electronics device, among other possibilities. In the case where a client 102 is a network device, the client 102 may be or may include a base station (BS) (e.g., eNodeB or gNodeB), router, access point (AP), personal basic service set (PBSS) coordinate point (PCP), among other possibilities. In the case where a client 102 is a private network, the client 102 may be or may include a private network of an institute (e.g., a hospital or financial institute), a retailer or retail platform, a company's intranet, etc.

In the case where a client 102 is an end user device, the local data 104 at the client 102 may be data that is collected or generated in the course of real-life use by user(s) of the client 102 (e.g., captured images/videos, captured sensor data, captured tracking data, etc.). In the case where a client 102 is a network device, the local data 104 at the client 102 may be data that is collected from other end user devices that are associated with or served by the network device. For example, a client 102 that is a BS may collect data from a plurality of user devices (e.g., tracking data, network usage data, traffic data, etc.) and this may be stored as local data 104 on the BS.

Regardless of the form of the client 102, the data collected and stored by each client 102 as local data 104 may be considered to be private data (e.g., restricted to be used only within a private network if the client 102 is a private network, or is considered to be personal data if the client 102 is an end user device), and it is generally desirable to ensure privacy and security of the local data 104 at each client 102.

Each client 102 is capable of executing a machine learning algorithm to train its local model 104 (i.e., update parameters of the local model 104) using its local data 104. For the purposes of the present disclosure, executing a machine learning algorithm at a client 102 means executing computer-readable instructions of a machine learning algorithm to update parameters of a machine learning model (which may be approximated using a neural network).

In the example of FIG. 1, each client 102 communicates with a central server 110 (also referred to as a central node). The communication between each client 102 and the central server 110 may be via any suitable network (e.g., the Internet, a P2P network, a WAN and/or a LAN) and may be a public network. Communications between the central server 110 and each client 102 may be secured (e.g., using suitable encryption and authentication techniques).

Although referred to in the singular, it should be understood that the central server 110 may be implemented using one or multiple servers. For example, the central server 110 may be implemented as a server, a server cluster, a cloud server, a distributed computing system, a virtual machine, or a container (also referred to as a docker container or a docker) running on an infrastructure of a datacenter, or infrastructure (e.g., virtual machines) provided as a service by a cloud service provider, among other possibilities. Generally, the central server 110 may be implemented using any suitable combination of hardware and software, and may be embodied as a single physical apparatus (e.g., a server) or as a plurality of physical apparatuses (e.g., multiple servers sharing pooled resources such as in the case of a cloud service provider). As such, the central server 110 may also generally be referred to as a computing system or processing system. In some examples, an end user device may provide the role of the central server 110; thus, it should be understood that the term “server” is not intended to limit the central server 110 to a specific hardware or network entity.

The central server 110 in general is a central entity that coordinates the training process in the system 100. The central server 110 may also perform operations to aggregate updates received from the clients 102 (e.g., to train a cluster model). The central server 110 may also perform operations to update clusters (e.g., cluster merging), as disclosed herein.

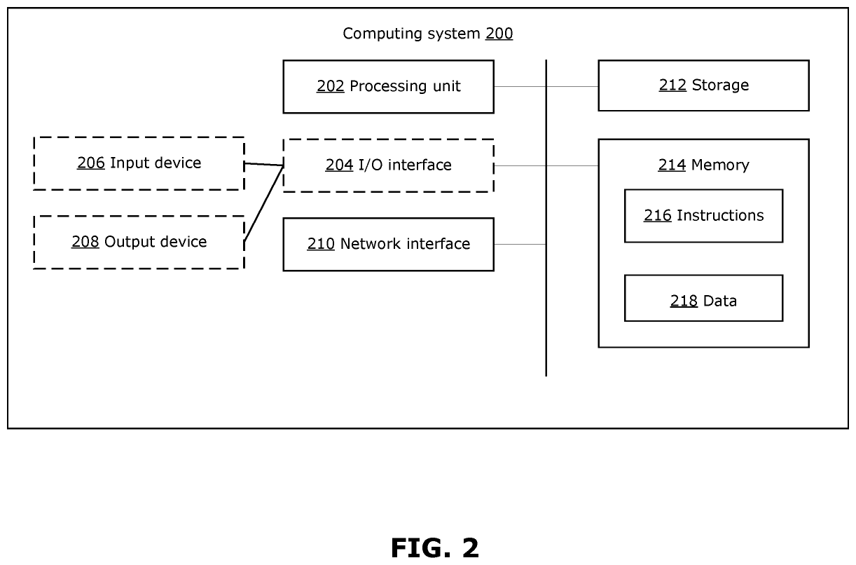

FIG. 2 is a block diagram illustrating a simplified example computing system 200, which may be used to implement the central server 110 or to implement any of the clients 102. Other examples suitable for implementing embodiments described in the present disclosure may be used, which may include components different from those discussed below. Although FIG. 2 shows a single instance of each component, there may be multiple instances of each component in the computing system 200.

The computing system 200 may include one or more processing units 202, such as a processor, a microprocessor, a digital signal processor, an application-specific integrated circuit (ASIC), a field-programmable gate array (FPGA), a dedicated logic circuitry, a dedicated artificial intelligence processor unit, a tensor processing unit, a neural processing unit, a hardware accelerator, or combinations thereof.

The computing system 200 may also include one or more optional input/output (I/O) interfaces 204, which may enable interfacing with one or more optional input devices 206 and/or optional output devices 208. In the example shown, the input device(s) 206 (e.g., a keyboard, a mouse, a microphone, a touchscreen, and/or a keypad) and output device(s) 208 (e.g., a display, a speaker and/or a printer) are shown as optional components of the computing system 200. In some examples, one or more input device(s) 206 and/or output device(s) 208 may be external to the computing system 200. In other example embodiments, there may not be any input device(s) 206 and output device(s) 208, in which case the I/O interface(s) 204 may not be needed.

The computing system 200 may include one or more network interfaces 210 for wired or wireless communication with other entities of the system 100. For example, if the computing system 200 is used to implement the central server 110, the network interface(s) 210 may be used for wired or wireless communication with the clients 102; if the computing system 200 is used to implement a client 102, the network interface(s) 210 may be used for wired or wireless communication with the central server 110 (and optionally with one or more other clients 102). The network interface(s) 210 may include wired links (e.g., Ethernet cable) and/or wireless links (e.g., one or more antennas) for intra-network and/or inter-network communications.

The computing system 200 may also include one or more storage units 212, which may include a mass storage unit such as a solid state drive, a hard disk drive, a magnetic disk drive and/or an optical disk drive.

The computing system 200 may include one or more memories 214, which may include a volatile or non-volatile memory (e.g., a flash memory, a random access memory (RAM), and/or a read-only memory (ROM)). The non-transitory memory (ies) 214 may store instructions 216 for execution by the processing unit(s) 202, such as to carry out example embodiments described in the present disclosure. The memory (ies) 214 may include other software instructions, such as for implementing an operating system and other applications/functions. In some example embodiments, the memory (ies) 214 may include software instructions 216 for execution by the processing unit(s) 202 to implement a machine learning algorithm, for example to update parameters of a machine learning model. The memory (ies) 214 may also store data 218, such as values of weights of a neural network.

In some example embodiments, the computing system 200 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. It should be understood that, unless explicitly stated otherwise, references to computer-readable medium in the present disclosure is intended to exclude transitory computer readable medium.

As noted above, FL is a machine learning technique that enables the clients 102 to participate in learning a model related to a task without having to share their local data 104 with the central server 110 or with other clients 102. In this way, FL may help to ensure privacy of the local data 104 (which, in many cases, may contain privacy-sensitive information such as personal photos or health data) while providing clients 102 with the benefits of a machine learning model that has been trained using large amounts of data.

Although FL may be considered a form of distributed optimization, FL is characterized by certain features that differentiate FL from other distributed optimization methods. One differentiating feature is that the number of clients 102 that participate in FL is typically much higher than the number of participants in distributed optimization (e.g., hundreds of devices compared to tens of devices). An important feature of FL is that the local data 104 of the clients 102 are typically non-IID (IID meaning “independent and identically-distributed”), meaning the local data 104 of different clients 102 are unique and distinct from each other, and it may not be possible to infer the characteristics or a distribution of the local data 104 at any one clients 102 based on the local data 104 of any other clients 102. The non-IID nature of the user data means that many (or most) of the methods that have been developed for distributed optimization are ineffective in FL.

To help understand how FL is used to train a machine learning model, it is useful to discuss a well-known approach to federated learning, commonly referred to as “FederatedAveraging” or FedAvg (e.g., as described by McMahan et al. “Communication-efficient learning of deep networks from decentralized data” AISTATS, 2017), although it should be understood that the present disclosure is not limited to the FedAvg approach.

In FedAvg, a centralized model (commonly referred to as a global model) is learned over several rounds of training. At the beginning of each round, the central server 110 sends the parameters of the global model (e.g., weights of the layers of the neural network that approximate the global model) to some of the clients 102. The central server 110 may select which of the clients 102 participate in a given round of training, for example by selecting clients 102 that did not participate in an immediately preceding round of training. The clients 102 that participate in a given round of training may be fewer than all the clients 102 that participate in training the global model, because it may be costly (e.g., in terms of communications costs, processing power, etc.) for all clients 102 to participate in every round of training. Each client 102 that is participating in the current round of training receives a copy of the parameters of the global model (also referred to as the global parameters) uses the received parameters to update its own local model 106.

Each client 102 then further trains the local model 106 using its own local data 104 (e.g., the training set in the local data 104) to update the parameters of the local model 106 (also referred to as the local parameters). For example, each client 102 may compute a gradient of a loss function with respect to the local parameters, and use the computed gradient to update the local parameters (e.g., using stochastic gradient descent). Information about the updated local model 106 (in particular, the updated local parameters) are sent back to the central server 110 by the client 102, typically in the form of the gradient. It may be appreciated that updates about the local model 106, sent by the client 102 to the central server 110, does not expose the local data 104 and thus help to ensure privacy of the local data 104.

The central server 110 aggregates the received updates from multiple clients 102 (e.g., from all clients 102 selected to participate in the current round of training) to update the global parameters. In the case of FedAvg, the update is performed by averaging the received gradients and adding the average of the received gradients to the current global parameters.

A drawback of the FedAvg approach to FL is that a single global model is learned, which may not be equally suitable for each client. For example, different data distribution of the local data in different clients may mean that the global model has good performance when deployed by some clients while having poor performance when deployed by other clients. Some existing FL approaches attempt to address this by clustering clients into client clusters. In general, clustering is a machine learning technique that involves grouping similar data points into clusters or subgroups based on their features. In FL, clustering aims to group clients having similar data distribution in their local data into the same cluster, such that a cluster model that is learned for that cluster has good performance for the clients belonging to that cluster.

Some existing techniques for FL using client clusters include Iterative Federated Clustering Algorithm (IFCA; described by Ghosh et al. arXiv: 2006.04088), Federated Stochastic Expectation Maximization (FeSEM; described by Long et al. arXiv: 2005.01026), Flexible Clustered Federated Learning (FlexCFL; described by Duan et al. arXiv: 2108.09749, and FedDrift (described by Wang et al. arXiv: 2206.00799). Many existing techniques for FL with client clusters requires a fixed number of clusters that is selected at the start of training (with the exception of FedDrift) and/or limit each client to membership in only one cluster.

A drawback of existing techniques that fix the number of clusters is that the number of clusters must be selected at the start, usually based on some assumption. If the selected number of clusters is too low, then some clients with significantly different data distributions will be clustered together, yielding a suboptimal cluster model for the clients in that cluster. On the other hand, if the selected number of clusters is too high, then some clients with similar data distributions will be assigned to different clusters, which again will result in suboptimal cluster models that are trained by less data in each cluster.

Another drawback of existing techniques is that each client is limited to membership in only one cluster. In real world application, the data distributions of the local data of different clients may be similar in some regions, while being significantly different in other regions. For example, client A may have local data with data distribution similar to that of clients B and C in a first region, but the local data of claim A may be significantly different to that of clients B and C in a second region. If each client can be a member of only one cluster, then clustering clients A, B and C together in the same cluster may result in clients A, B and C learning a cluster model that performs well in the first region but performs poorly in the second region. Alternatively, if client A is assigned to its own cluster and clients B and C are assigned together to a different cluster, the cluster model for client A may suffer from a lack of training data.

Existing techniques that limit each client to membership in a single cluster also may not perform will in an asymmetric scenario, in which clients do not benefit equally. Consider an example in which two different types of clients participate in FL. Type 1 clients have local data that contains a lot of noise, while Type 2 clients have local data that is more precise. Since Type 1 clients have noisy data, Type 1 clients will benefit from aggregating their model updates with model updates from Type 2 clients due to the more precise data of Type 2 clients. However, Type 2 clients may experience a decrease in predictive accuracy of their model when aggregated with the model updates from Type 1 clients due to the noisy nature of the data at Type 1 clients. Hence, a first cluster of both Type 1 and Type 2 clients may learn a cluster model that is better for Type 1 clients, while a second cluster of only Type 2 clients may learn a cluster model that is better for Type 2 clients. In this scenario, it is desirable for Type 2 clients to be members of both clusters, which is not permitted in existing clustering techniques in FL.

Examples disclosed herein may address at least some of the above-discussed drawbacks of existing techniques for FL with client clustering. The FL technique disclosed herein may include an initialization phase (also referred to as a pre-training phase) and a training phase. The initialization phase may be performed to obtain initial cluster definitions that will be used at the start of the training phase. A cluster definition may define the set of client(s) belonging to a given cluster. The cluster definitions may change over the training phase. Each client is included in at least one cluster and may be included in two or more clusters.

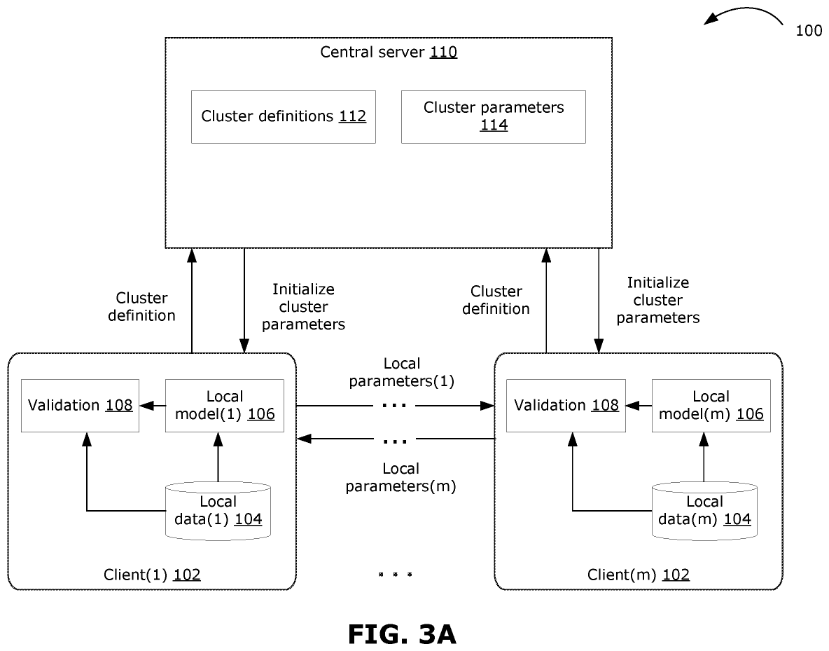

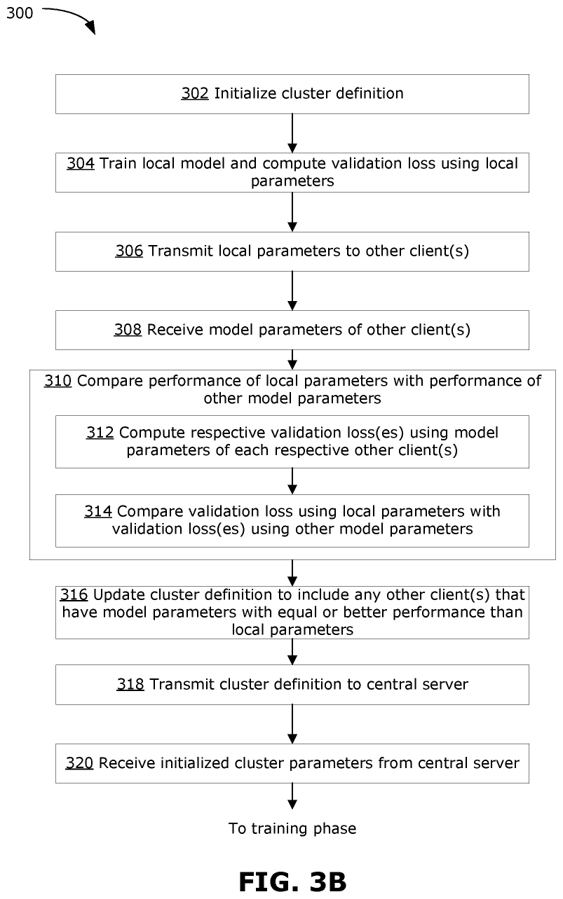

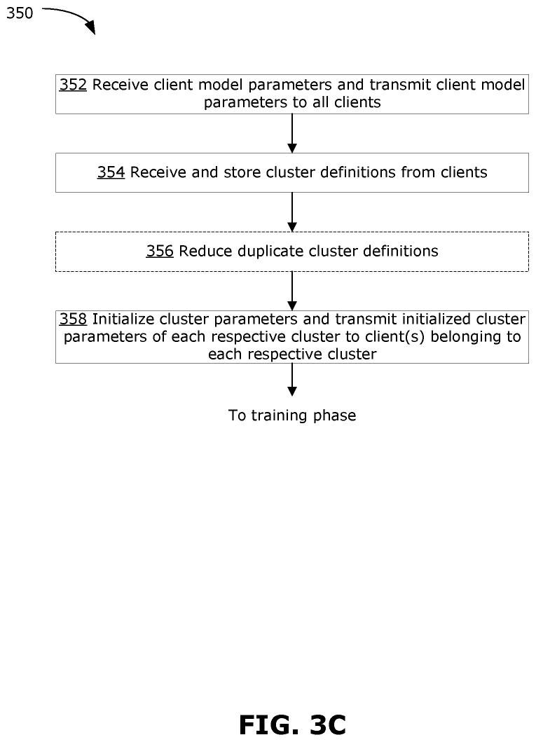

FIG. 3A is a block diagram illustrating more details of the system 100, including details that may be used to implement examples disclosed herein for FL with client clustering. In particular, FIG. 3A illustrates details of the system 100 that may be relevant for understanding the operation of the clients 102 and the central server 110 during an initialization phase.

For simplicity, the central server 110 has been illustrated as a single server (e.g., implemented using an instance of the computing system 200). However, it should be understood that the central server 110 may actually be a virtual server or virtual machine that is implemented by pooling resources among a plurality of physical servers, or may be implemented using a virtual machine or container (also referred to as a docker container or a docker) within a single physical server, among other possibilities.

The central server 110 in this example stores a set of cluster definitions 112, which may be used to identify which clients 102 belong in the same cluster. The central server 110 may additionally store cluster parameters 114. Each set of cluster parameters 114 is the parameters (e.g., the parameters whose values have been learned or will be learned through FL) for the cluster model of a cluster. Each set of cluster parameters 114 is associated with a respective cluster (e.g., the central server 110 may map each set of cluster parameters 114 to a respective cluster definition 112 or vice versa), and the cluster parameters 114 of a given cluster represents the model that is collaboratively learned using information from the client(s) 102 belonging to the given cluster.

Each client 102 is shown as having similar configuration, for simplicity. However, it should be understood that different clients 102 may have different configurations. For example, one client 102 may have access to multiple different memories storing different sets of local data 104. In the example shown, each client 102 stores respective local data 104 (local data(1) 104 to local data(m) 104, generally referred to as local data 104), and includes a respective local model 106 (local model(1) 106 to local model(m) 106, generally referred to as local model 106). It may be noted that the local model 106 may be different models (e.g., having different respective local parameters). Each local model 106 may be implemented using a respective neural network, which may be trained using the training set of the respective local data 104.

Each client 102 may also include a validation module 108 that may be executed to perform validation of a model. For example, the validation module 108 may perform validation of the local model 106 by inputting the validation set of the local data 104 into the local model 106 and obtaining the output, then computing the validation loss.

In examples of the present disclosure, the term “model” may be used as shorthand for the model executed using a particular set of parameters. For example, the “local model” of the i-th client may refer to the model when executed using the local parameters of the i-th client (i.e., the parameters learned from training using the local data of the i-th client); an “other client model” may refer to the model executed using the model parameters from another client (i.e., the model parameters learned by the other client from training using the local data of the other client); a “cluster model” may refer to the model executed using the cluster parameters learned from collaborating with other clients in the same cluster; and “other cluster model” may refer to the model executed using the cluster parameters from a different cluster (i.e., the model parameters collaboratively learned by the clients in the different cluster).

FIG. 3A illustrates each client-to-client communications (e.g., communication of local parameters between clients 102). This may be performed over sidelink communication channels, for example. In some examples, a client 102 may communication with another client 102 via the central server 110 or via another network entity (e.g., via a base station).

The initialization phase is now described with reference to FIG. 3B. FIG. 3A may be referenced to assist in understanding of FIG. 3B.

FIG. 3B is a flowchart illustrating an example method 300, which may be performed by a client 102 in the example of FIG. 3A. The method 300 may illustrate steps that are performed by a given client 102 in the initialization phase prior to the training phase.

If the number of clients 102 in the system 100 is denoted as m, then the method 300 may be performed by each of the m clients in parallel (e.g., each step of the method 300 may be performed by each of the m clients in parallel). In some examples, the central server 110 may send communications to each of the clients 102 in the system 100 to coordinate the initialization phase. For example, the central server 110 may send communications to trigger initialization of the cluster definition in each client 102 at step 302 and/or to trigger transmission of local parameters by each client 102 at step 306.

For convenience, the method 300 will be discussed below as being performed by the i-th client.

At 302, a cluster definition is initialized at the i-th client. The cluster definition is initialized to define the i-th cluster having only the i-th client. That is, Cᵢ={cᵢ}, where Cᵢ denotes the i-th cluster and cᵢ denotes the i-th client.

At 304, the i-th client trains its local model (i.e., performs training using the training set of the local data, to learn the values of the local parameters), denoted wᵢ, and computes a validation loss (e.g., using the validation module 108), denoted valᵢ, using the learned local parameters. The computed validation loss is stored. In some examples, step 304 may be performed prior to the method 300.

At 306, the i-th client transmits its local parameters to other client(s) in the system 100. For example, the i-th client may transmit its local parameters to each other client of the m clients in the system 100.

At 308, the i-th client receives model parameters of other client(s) in the system 100. Following completion of steps 306 and 308 by each of the m clients, each client should have its own local parameters as well as the model parameters of m−1 other clients.

As illustrated in FIG. 3A, client(1) may transmit its local parameters (referred to as local parameters(1)) to each other client(m), and client(1) may receive local parameters(m) of each other client(m). Although FIG. 3A illustrates the communication of local parameters between clients 102 as client-to-client communications (e.g., over a sidelink), in some examples the communication of local parameters may be via the central server 110. For example, each client 102 may, after training its local model 104, upload its respective local parameters to the central server 110. Then the central server 110 may communicate (e.g., via broadcast) the received local parameters to all clients 102.

At 310, the i-th client compares the performance of its own local model (i.e., the model executed using its own local parameters) with performance of each of the other client models from other clients (i.e., the model executed using the model parameters of each other client). This comparison may be performed to enable the i-th client to determine whether it is beneficial or not to be clustered with another client. For example, the comparison may be performed using validation loss as an indicator of the model performance, such as using steps 312 and 314.

At 312, the i-th client computes respective validation loss(es) (e.g., using the validation module 108) using the model parameters of each respective other client(s). That is, for a j-th set of model parameters of a respective j-th client, the i-th client inputs the validation set of the local data into a model using the j-th set of model parameters and computes a j-th validation loss and stores the j-th validation loss, denoted valᵢ. Following completion of step 310, the i-th client has stored the validation loss computed using its own local parameters (denoted valᵢ) as well as m−1 other validation loss(es) computed using model parameters of each of the m−1 other client(s) (denoted valᵢ^{j}), where j=1, . . . ,m, j≠i).

At 314, the validation loss computed using the local parameters (i.e., valᵢ) is compared with the validation loss(es) computed using the m−1 other model parameters (e.g., valᵢ^{j}).

The comparison at step 314 may be performed using any suitable statistical technique. For example, valᵢ^{j} may be determined to be better than valᵢ if valᵢ^{j}<valᵢ. However, such a direct comparison may be subject to false positives due to the presence of random fluctuations. Other statistical techniques may be used that may be more suitable. For example, a statistical paired test, such as the Wilcoxon signed rank test or a paired t-test may be used to determine whether the null hypothesis valᵢ+ϵ<valᵢ^{j} holds true (where e denotes some small margin of error). If the null hypothesis is true, then valᵢ^{j} is not better than valᵢ. Conversely, if the p-value is significantly small (e.g., less than 0.05), then the null hypothesis is rejected, which means the validation loss indicates that the local parameters do not perform better than the model parameters from the j-th client. This comparison is performed for each of the m−1 other model parameters.

The performance of the local model (i.e., the model executed using the i-th client's own local parameters) is thus compared with performance of the j-th other client model (i.e., the model executed using the model parameters of the j-th client), for example by comparing the validation loss as discussed above. If the performance of the model executed using the model parameters of the j-th client is equal or better than the model executed using the i-th client's own local parameters, this indicates that the i-th client may benefit from adding the j-th client to the cluster.

At 316, the cluster definition at the i-th client is updated to include any other client(s) that have model parameters with equal or better performance than the i-th client's own local parameters. That is, if the performance of the j-th other client model (i.e., the model executed using the model parameters of the j-th client) is equal or better than the performance of the local model at the i-th client (i.e., the model executed using the i-th client's own local parameters) (e.g., the null hypothesis discussed above is rejected), then the i-th client updates its cluster definition to include j-th client such that Cᵢ={cᵢ, cⱼ}. Following completion of step 316, the cluster definition at the i-th client includes the i-th client as well as each other client whose model parameters have equal or better performance than the local parameters of the i-th client.

It should be understood that steps 310 to 316 may be performed for one set of received model parameters at a time. For example, the i-th client may perform steps 310 to 316 for the model parameters of the j-th client, to update (or not update) the cluster definition at the i-th client to include the j-th client; then the i-th client may repeat steps 310 to 316 for the model parameters of the k-th client, to update (or not update) the cluster definition to include the k-th client; and so forth. In other examples, steps 310-314 may be performed for all received model parameters such that step 312 is performed for all of the m−1 other model parameters, then step 314 is performed to perform m−1 comparisons, and then step 316 to update the cluster definition to include the client(s) having the model parameters that have equal or better performance.

At 318, the i-th client transmits its updated cluster definition to the central server. As illustrated in FIG. 3A, each client may transmit its respective client definition (after updating at step 316) to the central server 110.

The central server 110 stores the received cluster definitions 112. It should be noted that because each client generates its own cluster definition, the central server 110 initially stores m cluster definitions 112 for m clients. If any two cluster definitions are the same, the central server 110 may merge the two clusters (e.g., as discussed further below with respect to FIG. 3C). For each cluster defined by the stored cluster definitions 112, the central server 110 initializes a respective set of cluster parameters 114. For example, the central server 110 may initialize each set of cluster parameters 114 with random parameter values. The initialized cluster parameters for a given cluster are communicated by the central server 110 to each client belonging to the cluster.

At 320, the i-th client receives from the central server 110 the initialized cluster parameters for each cluster that the i-th client belongs to. Thus, each client that belongs to the same cluster has the same initialized cluster model. Additionally, because a client may belong to more than one cluster, each client may have more than one initialized cluster model.

FIG. 3C is a flowchart illustrating an example method 350, which may be performed by the central server 110 in the example of FIG. 3A. The method 350 may illustrate steps that are performed by the central server 110 in the initialization phase prior to the training phase. It should be understood that the method 300 and the method 350 may be carried out in parallel, and that the methods 300 and 350 together illustrate how the clients 102 and central server 110 operate together in the initialization phase.

At 352, the central server receives client model parameters from each client in the system and transmits the received client model parameters to all other clients. As previously mentioned, in some examples clients may directly communicate the client model parameters with each other (e.g., via sidelink communications) and step 352 may be omitted.

As previously discussed, each client may perform operations to compare the performance of its own local parameters with the performance of other parameters of other clients (e.g., at step 310), update its own cluster definition based on the comparison (e.g., at step 316) and transmit the cluster definition to the central server (e.g., at step 318).

At 354, the central server receives and stores the cluster definitions from the clients (e.g., stored as cluster definitions 112 at the central server). As previously mentioned, each cluster definition (which is generated by a respective client) defines the set of client(s) belonging to a respective cluster.

Optionally, at 356, the central server may reduce any duplicate cluster definitions. Because each client determines its own cluster definition, the central server may receive the same cluster definition (i.e., the same set of clients is defined) from two clients. In this case, the central server may reduce the duplicate cluster definitions by storing only one of the two identical cluster definitions. For example, if C₁={c₁, c₂, c₃} and C₂={c₁, c₂, c₃} (i.e., the 1-st client and the 2-nd client have generated identical cluster definitions), then the central server may store one cluster definition C₁={c₁, c₂, c₃} instead of two separate but identical cluster definitions. Thus, the central server receives m cluster definitions from m clients, however the number of cluster definitions stored and maintained by the central server may be fewer than m.

At 358, the central server initializes a set of cluster parameters for the respective cluster model of each respective cluster and transmits the initialized cluster parameters of each respective cluster to the client(s) belonging to each respective cluster (as defined by the cluster definitions). The central server may initialize each set of cluster parameters using random values, for example. Notably, all the client(s) belonging to a given cluster receives the same initialized cluster parameters, thus the cluster model is initialized for all the client(s) belonging to that given cluster.

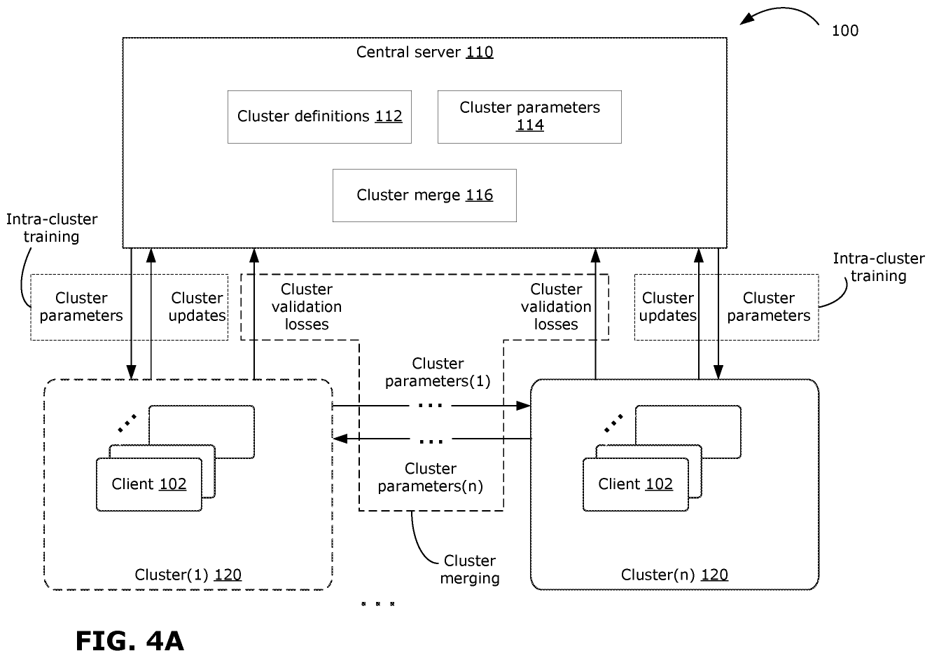

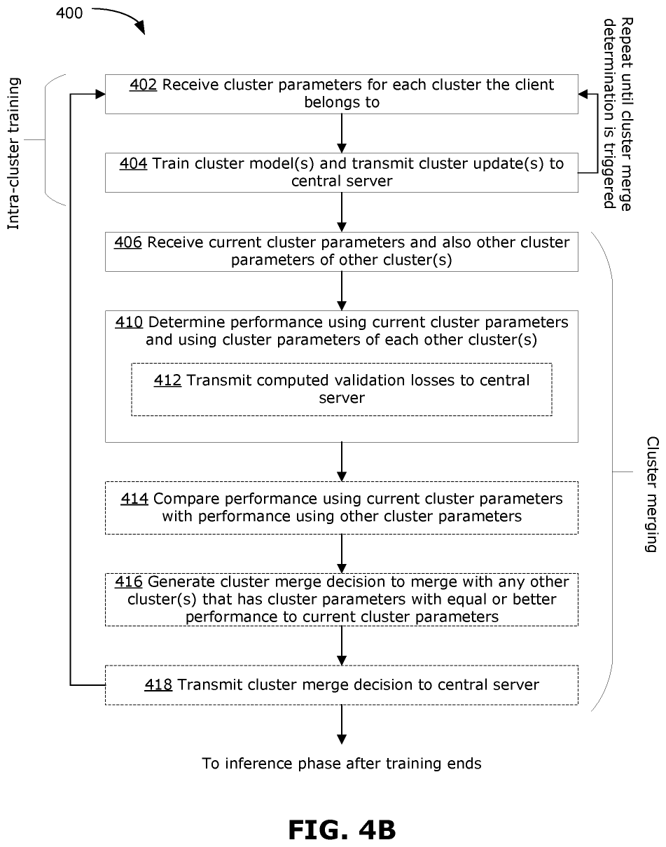

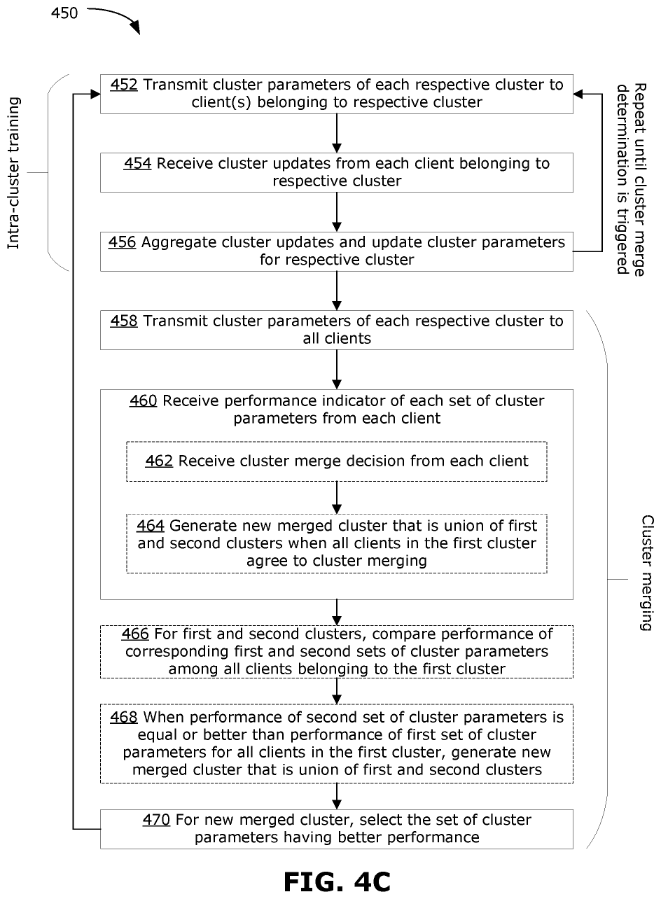

Following the initialization phase (e.g., carried out by the clients using the method 300 and by the central server using the method 350), the training phase may begin. The training phase is now described with reference to FIG. 4A.

FIG. 4A is a block diagram illustrating more details of the system 100, including details that may be used to implement examples disclosed herein for FL with client clustering. In particular, FIG. 4A illustrates details of the system 100 that may be relevant for understanding the operation of the clients 102 and the central server 110 during a training phase.

For simplicity, the central server 110 has been illustrated as a single server (e.g., implemented using an instance of the computing system 200). However, it should be understood that the central server 110 may actually be a virtual server or virtual machine that is implemented by pooling resources among a plurality of physical servers, or may be implemented using a virtual machine or container (also referred to as a docker container or a docker) within a single physical server, among other possibilities.

In addition to the stored cluster definitions 112 and cluster parameters 114, the central server 110 may also include a cluster merge module 116. The cluster merge module 116 may be used to perform cluster merge operations (e.g., determine whether two different clusters should be merged into a single cluster, based on validation losses computed by clients of the two clusters; and update cluster definitions 112 to reflect the merged cluster).

FIG. 4A shows the clients 102 being clustered into multiple clusters 120 (cluster(1) 120 to cluster (n) 120, generally referred to as cluster 120). Each cluster 120 includes one or more clients 102 (e.g., a cluster 120 may have a minimum of one client 102, up to a maximum of all m clients 102), as defined by the cluster definitions 112 maintained by the central server 110. It should be noted that a given client 102 may be a member of more than one cluster 120. Further, each client 102 should be a member of at least one cluster 120.

The training phase includes intra-cluster training, during which clients 102 of each given cluster 120 collaboratively train a cluster model for the given cluster 120; and cluster merging, during which performance of different cluster models are compared to determine whether clusters should be merged. Further details of the training phase are now discussed with reference to FIG. 4B. For simplicity, the training phase will be first described with reference to operations at a client (which may be any arbitrary client). The operations at the central server will be later described. However, it should be understood that the clients and the central server operate collaboratively to enable FL using client clusters.

FIG. 4B is a flowchart illustrating an example method 400, which may be performed by one of the clients 102 in the example of FIG. 4A. The method 400 may illustrate steps that are performed by the client 102 in the training phase.

The training phase may be divided into intra-cluster training operations (e.g., steps 402 to 404) and cluster merging operations (e.g., steps 406 to 418).

Steps 402-404 may be performed by the client to conduct rounds of intra-cluster training within each cluster that the client belongs to, to train respective cluster models (i.e., to learn the cluster parameters of the cluster model of each cluster).

At 402, the client receives, from the central server, cluster parameters for each cluster that the client belongs to. For example, if the client belongs to the i-th cluster (denoted Cᵢ) and the j-th cluster (denoted Cᵢ), the client receives from the central server the i-th cluster parameters (i.e., the most recent cluster parameters that have been collaboratively learned by the clients belonging to the i-th cluster) and the j-th cluster parameters (i.e., the most recent cluster parameters that have been collaboratively learned by the clients belonging to the j-th cluster). It may be appreciated that in the special case where this is the first round of training, the cluster parameters may be the initialized cluster parameters from step 320 of the method 300.

At 404, for each cluster that the client belongs to, the client trains the cluster model and transmits a cluster update to the central server. For example, if the client belongs to the i-th cluster and the j-th cluster, the client uses the training set of its local data to train the cluster model of the i-th cluster (i.e., to learn updated values of the cluster parameters for the i-th cluster), and repeats this training for the cluster model of the j-th cluster. The client transmits the cluster update for each of the clusters the client belongs to. For example, if the client belongs to the i-th cluster and the j-th cluster then the client transmits a cluster update for the i-th cluster and a cluster update for the j-th cluster. Each transmitted cluster update may be identified as being associated with a respective cluster. The cluster update that is transmitted may be the updated cluster parameters, or may be a gradient that represents the difference between the previous cluster parameters and the updated cluster parameters.

The central server receives the cluster updates from all clients. Each received cluster update is associated with a respective cluster. For each given cluster, the central server performs operations to aggregate the cluster updates for that given cluster (e.g., using weighted averaging, or other suitable FL techniques) and update the cluster model (i.e., update the cluster parameters for the cluster model of that given cluster). The central server may maintain the updated cluster model (e.g., the updated cluster parameters may be stored as the cluster parameters 114 of that given cluster). Then the central server transmits the updated cluster parameters to each client of that given cluster (e.g., to each client belonging to that given cluster, as defined by the cluster definition 112 of that given cluster) and the method returns to step 402 for another round of intra-cluster training.

Thus, during intra-cluster training, the clients belonging to the same cluster collaboratively trains the cluster model of that cluster. Since a client may belong to more than one cluster, a client may contribute to the training of more than one cluster model.

During intra-cluster training, each cluster may perform rounds of training in a synchronous manner (e.g., a round of training starts at the same time for all clusters) or in an asynchronous manner (e.g., each cluster may start a round of training independent of each other cluster). The central server may perform operations to coordinate training within each cluster as well as to coordinate training between different clusters (e.g., the central server may stagger training of different clusters to manage use of communication resources).

During the training phase, a determination may be made whether two different clusters should be merged into a single cluster (where the new merged cluster is defined as the union of the clients originally belonging to the two different clusters). Cluster merging may be useful in the case where two different clusters represent clients having similar or same local data distributions, but where the clients in the two clusters are slightly different. Because clusters are defined in the initialization phase based on the clients' local models, the clusters may not be optimized (e.g., due to limited local data being available to train local models). Early in the training phase, the cluster models of the two clusters may appear to be different (e.g., having different parameter values). may appear to be different, but after further training, the two cluster models may converge (e.g., the parameter values of the two cluster models may become similar), which may indicate that merging the two clusters would be beneficial. Cluster merging may also be useful in examples where client partitioning (as discussed further below) is performed.

A cluster merger determination may be triggered following one or more rounds of intra-cluster training. For example, the central server may, after a predetermined number of intra-cluster training iterations (which may be hyperparameter that may be set) or after a predetermined time period of intra-cluster training (which may be another hyperparameter that may be set), trigger the start of cluster merger determination. Other trigger conditions may be possible.

In some examples, the central server may, after the trigger condition has been met, broadcast a trigger signal to all clients to indicate the start of cluster merger determination. In other examples, an explicit trigger signal may not be needed (e.g., the client may determine, from receiving cluster parameters of other cluster(s) at step 406, that cluster merger determination has started). Steps 406-418 may be performed by the client to determine whether two given clusters (at least one of which the client currently belongs to) should be merged.

For simplicity, the following discussion will describe steps for determining whether two clusters, namely the i-th cluster Cᵢ and the j-th cluster Cⱼ, should be merged. However, it should be understood that this discussion may be generalized to determine merging of any two or more clusters.

At 406, the client receives the current cluster parameters of the cluster it currently belongs to, as well as other cluster parameters of other cluster(s). For example, FIG. 4A illustrates cluster parameters being communicated directly between clients 102 of different clusters 120 (e.g., via sidelink communications). In other examples, the central server 110 may broadcast the stored cluster parameters 114 to the clients 102 of different clusters 120.

For example, if the client is the k-th client (denoted cₖ) in the system 100 and initially belongs to the i-th cluster Cᵢ, then the k-th client cₖ receives the cluster parameters for both the current i-th cluster Cᵢ as well as the other j-th cluster Cⱼ. The model executed using the current cluster parameters of the current i-th cluster Cᵢ may be referred to as the i-th cluster model, denoted mᵢ, for simplicity; similarly, the model executed using the other cluster parameters of the other j-th cluster Cⱼ may be referred to as the j-th cluster model, denoted mⱼ, for simplicity. Step 406 is performed by each client belonging to the union of clusters Cᵢ and Cⱼ, such that each client in clusters Cᵢ and Cⱼ has received the cluster models mᵢ and mⱼ.

At 410, the client determines the performance of the model using the current cluster parameters, as well as the performance of the model using the other cluster parameters of each other cluster(s). In some examples, the performance of the model may be evaluated using a computed validation loss. Thus, the client computes the validation loss using the current cluster parameters, as well as the validation loss using the other cluster parameters of each other cluster(s).

In the example of the k-th client cₖ described above, the validation set of the local data is used to validate the cluster models mᵢ and mᵢ, to obtain validation losses lₖⁱ and lₖ^{j}, where lₖⁱ is the validation loss of the i-th cluster model mᵢ (i.e., the model executed using the cluster parameters of the i-th cluster) and lii is the validation loss of the j-th cluster model mⱼ (i.e., the model executed using the cluster parameters of the j-th cluster) when validated by the k-th client. Step 410 is performed by each client in clusters Cᵢ and Cⱼ.

Step 410 may optionally include step 412, in which the client transmits the computed validation losses as a performance indicator to the central server. In the example of clusters Cᵢ and Cⱼ described above, each client in clusters Cᵢ and Cⱼ may transmit the computed validation losses to the central server, such that the central server collects the validation losses computed by each client in clusters Cᵢ and Cⱼ with respect to each cluster model mᵢ and mⱼ.

If step 412 is performed by the client, then steps 414 to 418 may be omitted. If step 412 is not performed by the client, then the method 400 may proceed to steps 414 to 418.

At 414, the client compares performance of the model using the current cluster parameters with performance of the model using other cluster parameters. If validation losses are computed (as described above) to represent performance of the models, then step 414 may be performed by comparing the computed validation losses. For example, a statistical test, such as the Wilcoxon signed rank test, a paired t-test or other paired statistical test, may be performed to determine whether the validation loss using the current cluster parameters is better than the validation loss using the other cluster parameters (i.e., to determine whether the cluster model mᵢ performs better than the other cluster model mⱼ on the validation set).

In the example of the k-th client, the performance of the i-th and j-th cluster models mᵢ and mⱼ may be compared by using the Wilcoxon signed rank test (or other suitable statistical test) to test the null hypothesis: lₖⁱ+ϵ<lₖ^{j}. If the test returns a p-value <0.05, then the null hypothesis is rejected and thus statistical comparison shows that the performance of the current cluster model mᵢ is not statistically better than the performance of the other cluster model mⱼ (or put another way, the performance of the other cluster model mⱼ is statistically equal or better than the performance of the current cluster model mᵢ) based on the validation set at the k-th client. This indicates that merging of clusters Cᵢ and Cⱼ would be acceptable to the k-th client.

At step 416, a cluster merge decision is generated to merge with any other cluster(s) having cluster parameters with equal or better performance (as determined at step 414) to the current cluster parameters. In the example of the k-th client, if the performance of the cluster model mᵢ is not statistically better than the performance of the cluster model mⱼ (e.g., the null hypothesis describe above is rejected) then the k-th client cₖ belonging to cluster Cᵢ generates a cluster merge decision to indicate agreement with merging of clusters Cᵢ and Cⱼ.

At step 418, the cluster merge decision is transmitted as a performance indicator to the central server. The central server may thus collect cluster merge decisions from all clients belonging to two different clusters that are candidates to be merged. For example, if clusters Cᵢ and Cⱼ are two different clusters that are candidates to be merged, the central server may collect the cluster merge decisions from all clients belonging to cluster Cᵢ. If the cluster merge decisions from all clients of cluster Cᵢ indicate that all clients in cluster Cᵢ agree with merging of clusters Cⱼ and Cⱼ, then the central server performs operations to generate a new merged cluster that is the union of the clusters Cᵢ and Cⱼ. The stored cluster definition 112 of the new merged cluster is the union of the clusters Cᵢ and Cⱼ, and the original cluster Cᵢ may be removed (e.g., by removing the corresponding cluster definition 112) . . . . The central server may select the cluster parameters 114 corresponding to the cluster model having better performance (e.g., lower validation losses computed by the clients) for the majority of clients in the new merged cluster to be the cluster parameters 114 for the new merged cluster. It should be noted that the cluster Cⱼ is not changed by the decision by the clients of cluster Cᵢ to merge with cluster Cⱼ. That is, cluster Cⱼ is maintained together with the new merged cluster that is the union of clusters Cᵢ and Cⱼ. However, if the clients of cluster Cⱼ also agree to merge with cluster Cᵢ, then cluster Cⱼ is replaced with the new merged cluster.

Following the cluster merging, the method 400 returns to the intra-cluster training phase (e.g., returning to step 402).

FIG. 4C is a flowchart illustrating an example method 450, which may be performed by the central server 110 in the example of FIG. 4A. The method 450 may illustrate steps that are performed by the central server 110 in the training phase. It should be understood that the method 400 and the method 450 may be carried out in parallel, and that the methods 400 and 450 together illustrate how the clients 102 and central server 110 operate together in the training phase.

The training phase may be divided into intra-cluster training operations (e.g., steps 452 to 456) and cluster merging operations (e.g., steps 458 to 470). At the start of the training phase, the central server has stored and maintained cluster definitions (e.g., generated in the initialization phase using the methods 300 and 350) that define which clients belong to which clusters.

Steps 452-456 may be performed by the central server to conduct rounds of intra-cluster training with each cluster, to train respective cluster models (i.e., to learn the cluster parameters of the cluster model of each cluster).

At 452, the central server transmits the cluster parameters of each respective cluster to the client(s) belonging to that respective cluster. For example, the central server transmits the i-th cluster parameters (i.e., the most recent cluster parameters that have been collaboratively learned by the clients belonging to the i-th cluster) to all clients belonging to the i-th cluster, according to the cluster definition maintained at the central server. It may be appreciated that in the special case where this is the first round of training, the cluster parameters may be the initialized cluster parameters from step 358 of the method 350.

At 454, the central server receives, from each client belonging to a respective cluster, a cluster update that represents an update to the cluster parameters for that respective cluster. For example, for a given i-th cluster, the central server receives cluster updates (e.g., in the form of gradients) from all clients belonging to the i-th cluster.

At 456, for each respective cluster, the central server aggregates the cluster updates for that respective cluster (e.g., using weighted averaging, or other suitable FL techniques) and updates the cluster parameters for that respective cluster. The central server may maintain the updated cluster model (e.g., the updated cluster parameters may be stored as the cluster parameters 114 of that respective cluster). Then the central server transmits the updated cluster parameters to each client of that given cluster (e.g., to each client belonging to that given cluster, as defined by the cluster definition 112 of that given cluster) and the method 450 returns to step 452 for another round of intra-cluster training.

As previously discussed, rounds of intra-cluster training may be synchronized among the clusters (e.g., a round of training starts at the same time for all clusters) or may be asynchronous (e.g., each cluster may start a round of training independent of each other cluster), and the timing of the intra-cluster training may be coordinated by the central server.

Cluster merging may be performed when a trigger condition (e.g., as discussed previously) is satisfied (e.g., after a predetermined number of intra-cluster training iterations). The central server may or may not transmit a signal to all clients to indicate the start of cluster merger determination. Steps 458-470 may be performed by the central server to determine whether two given clusters should be merged and to merge the two clusters.

For simplicity, the following discussion will describe steps for determining whether two clusters, namely the i-th cluster Cⱼ and the j-th cluster Cⱼ, should be merged. However, it should be understood that this discussion may be generalized to determine merging of any two or more clusters.

At 458, the central server transmits the current cluster parameters of each respective cluster to all clients. As previously mentioned, in some examples clients belonging to different clusters may directly communicate cluster parameters with each other (e.g., via sidelink communications) and step 458 may be omitted. For example, the cluster parameters of the cluster model for the i-th cluster Cᵢ (which may be referred to as the i-th cluster model, denoted mᵢ, for simplicity) and the cluster parameters of the cluster model for the j-th cluster Cⱼ (which may be referred to as the j-th cluster model, denoted mⱼ, for simplicity) is transmitted by the central server to all clients belonging to the i-th cluster Cᵢ as well as all clients belonging to the j-th cluster Cⱼ (i.e., to the clients belonging to the union of the i-th and j-th clusters Cⱼ and Cⱼ).

At 460, the central server receives from the clients a performance indicator based on the performance of each set of cluster parameters at each client (i.e., based on how well the model executed using each set of cluster parameters performs on the validation set of the local data of each client). The performance indicators may be the validation losses computed at the clients, or the performance indicators may be the cluster merge decisions determined at the clients, as described previously. The central server uses the performance indicators to determine whether or not two given clusters should be merged into a new merged cluster, as discussed below.

If the clients transmits their computed validation losses to the central server (e.g., at step 412), then the performance indicator received from a given client represents the performance of a particular set of cluster parameters on the validation set of that given client. For example, the central server may receive validation losses representing performance of the i-th cluster model mᵢ (i.e., the model executed using the cluster parameters of the i-th cluster) at each client in clusters Cᵢ and Cⱼ, as well as validation losses representing performance of the j-th cluster model mⱼ (i.e., the model executed using the cluster parameters of the j-th cluster) at each client in clusters Cᵢ and Cⱼ.

If the clients perform steps 414-418 locally to determine their own cluster merge decision, then at optional step 462 the central server receives the cluster merge decision from each client in clusters Cᵢ and Cⱼ. At optional step 464, if all clients of a first cluster (e.g., cluster Cᵢ) agree to merging with a second cluster (e.g., the cluster merge decision received from each client in cluster Cᵢ indicate a positive cluster merge decision with respect to cluster Cⱼ), then the central server generates a new cluster definition that is the union of the clients in the two clusters (e.g., generates a new cluster definition C_{new}=Cᵢ∪Cⱼ). The new cluster definition may then be stored (e.g., in the cluster definitions 112 maintained by the central server 110) and the cluster definitions of the original first cluster (e.g., cluster Cᵢ) may be deleted. It should be noted that if the cluster merge decisions from all clients in the second cluster (e.g., cluster Cⱼ) also agree to merging with the first cluster (e.g., cluster Cᵢ), then the cluster definition of the second cluster may also be deleted. In such a case, the new merged cluster replaces the two original clusters.

If steps 462-464 are performed, then steps 466-468 may be omitted. If steps 462-464 are not performed (e.g., cluster merge decision is not determined by clients), then the method 450 may proceed to steps 466-468. For example, steps 466-468 may be performed by the central server 110 using the cluster merge module 116.

At 466, for first and second clusters (e.g., clusters Cⱼ and Cⱼ), the central server compares performance of the corresponding two sets of cluster parameters among all clients in the first cluster. If the performance indicators received from the clients are validation losses, then step 466 may be performed by comparing the validation losses computed for the two sets of cluster parameters by each client in the first cluster. For example, a statistical test, such as the Wilcoxon signed rank test, a paired t-test or any other suitable paired statistical test, may be performed to determine whether the validation loss using the second set of cluster parameters (from the second cluster) is equal to or better than the validation loss using the first set of cluster parameters (from the first cluster).

For example, the performance of the i-th and j-th cluster models mᵢ and mⱼ at each k-th client (where the k-th client is an arbitrary client belonging to tcluster Cᵢ) may be compared by using the Wilcoxon signed rank test (or other suitable statistical test) to test the null hypothesis: lₖⁱ+ϵ<lₖ^{j}. If the test returns a p-value <0.05, then the null hypothesis is rejected and thus statistical comparison shows that the performance of the second cluster model mⱼ is statistically equal or better than the performance of the first cluster model mᵢ at the k-th client of cluster Cᵢ. This comparison is performed for each client in cluster Cᵢ.

At step 468, when the performance of the second set of cluster parameters (representing cluster model mⱼ) is equal or better than the performance of the first set of cluster parameters (representing cluster model mᵢ) for all clients in cluster Cᵢ (e.g., the null hypothesis describe above is rejected), then a new merged cluster is generated. The new merged cluster has a cluster definition that is the union of the clients in the two clusters (e.g., generate a new cluster definition Chew=Cᵢ∪Cⱼ). The new cluster definition may then be stored (e.g., in the cluster definitions 112 maintained by the central server 110) and the cluster definitions of the original first cluster may be deleted. It should be noted that if the first set of cluster parameters (representing cluster model mᵢ) is also equal or better than the performance of the second set of cluster parameters (representing cluster model mⱼ) for all clients in the second cluster (e.g., cluster Cⱼ), then the cluster definition of the second cluster may also be deleted. In such a case, the new merged cluster replaces the two original clusters.

Regardless of how the central server determines that the two clusters should be merged (e.g., based on the cluster merge decisions received from the clients, or based on comparison of the performance of the two cluster models by the central server), after the cluster merge determination and merging of the two clusters, the method 450 proceeds to step 470.

At 470, for a new cluster that is generated by merging two given clusters (e.g., for a new cluster C_{new} generated by merging clusters Cⱼ and Cⱼ), the central server may select the cluster parameters corresponding to the cluster model having better performance (e.g., lower validation losses computed by the clients) for the majority of clients in the new merged cluster to be the cluster parameters for the new merged cluster. This may be stored in the cluster parameters 114 maintained by the central server.

Following the cluster merging, the method 450 returns to the intra-cluster training phase (e.g., returning to step 452).

The training phase (including intra-cluster training as well as cluster merging) may be performed until a convergence condition is met (e.g., a maximum number of training iterations has been performed, or all cluster models have converged). Following the end of training (e.g., carried out by the clients using the method 400 and by the central server using the method 450), the trained cluster models may be used for inference (e.g., to generate predictions) in the inference phase.

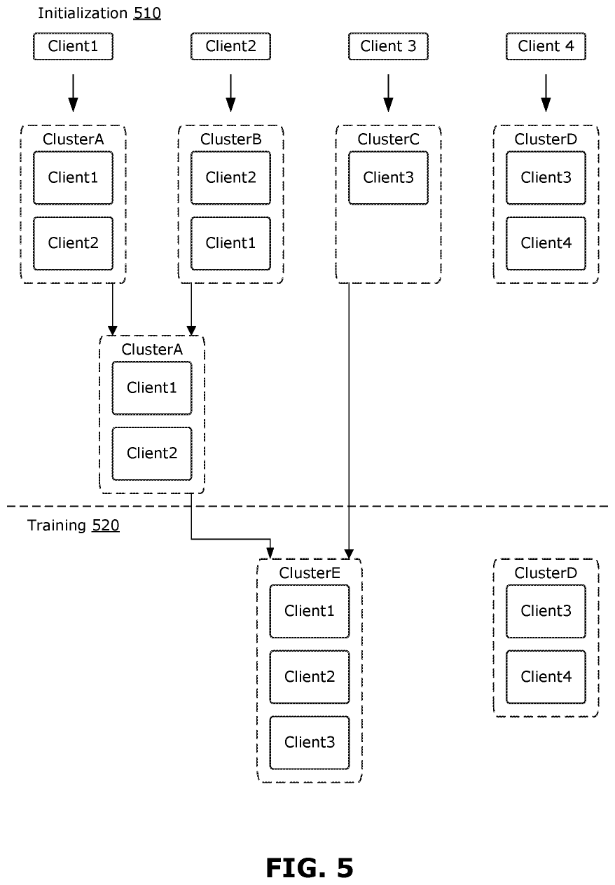

FIG. 5 illustrates an example implementation of the methods described above in a simplistic example in which there are only four clients (namely Client1, Client2, Client3 and Client4) in the FL system. It should be understood that in real-world implementation, there may be a much larger number of clients (e.g., hundreds or thousands of clients, or more) in the FL system.

In this example, in the initialization phase 510, using methods 300 and 350, the four clients determine their own cluster definitions. Client1 determines a cluster definition ClusterA={Client1, Client2}; Client2 determines a cluster definition ClusterB={Client2, Client1}; Client3 determines a cluster definition ClusterC={Client3}; and Client4 determines a cluster definition ClusterD= {Client3, Client4}. Because the cluster definitions for ClusterA and ClusterB are identical (i.e., the set of clients is the same in both cluster definitions), the central server may reduce the duplicate cluster definitions by keeping only the cluster definition for ClusterA (or alternatively by keeping only the cluster definition for ClusterB). Notably, Client3 belongs to more than one cluster.

In the training phase 520, the clients of each cluster collaborate to train a respective cluster model. For example, Client1 and Client2 perform operations to train the cluster model for ClusterA; Client3 performs operations to train the cluster model for ClusterCⱼ and Client3 and Client 4 perform operations to train the cluster model for ClusterD. The training phase 520 includes operations by the clients and central server to determine whether clusters should be merged (e.g., using steps 406-418 of method 400; and steps 458-470 of method 450). In this example, ClusterA and ClusterC should be merged, with the result being ClusterE that is a union of ClusterA and ClusterC. In this example, the new merged ClusterE replaces bother ClusterA and ClusterC because the clients of both ClusterA and ClusterC agree with the cluster merging.

Using the techniques disclosed herein, the clients and central server may perform operations to enable more flexible and adaptive client clustering during FL. In particular, a given client may belong to one, two or more clusters. Further, the number of clusters may be adaptively adjusted (e.g., via cluster merging) during training.

It should be understood that the present disclosure is not limited to the FL system 100 illustrated in FIG. 1, 3A or 4A. Examples of the present disclosure may be implemented in any suitable FL system. For example, instead of one central server that maintains all cluster definitions and cluster parameters, the FL system 100 may instead have multiple central servers, where each central server is responsible for maintaining and updating the cluster parameters for a corresponding cluster. Each central server may receive cluster updates from the clients belonging to that corresponding cluster. In such an embodiment, two central servers that manage two different clusters may communicate with each other to determine whether the two clusters should be merged, and one central server (e.g., the central server that maintains the cluster parameters found to have better performance among the clients of the two clusters) may be responsible for the new merged cluster.

In some examples, the clients of the FL system may be partitioned into two or more client groups. For example, the central server may partition clients into client groups randomly or based on client similarity (e.g., similar geographical location; similar device type; similar communication bandwidth; etc.). The clients may be partitioned into client groups of equal or approximately equal size (i.e., the number of clients in each client group may be equal or approximately equal). In other examples, the client groups may be unequal in size. The above-discussed methods (e.g., methods 300 and 350 for the initialization phase, and methods 400 and 450 for the training phase) may be performed for the clients within each client group. That is, FL may be used to initialize and train cluster models for clusters formed by clients of a given client group, without collaborating with clients or clusters of a different client group. After the training phase has completed for all of the client groups, each client group has converged on a respective set of cluster models. A further cluster merging may then be performed to determine if two clusters in respective two client groups should be merged.

As will be discussed further below, client partitioning may be useful to help reduce the amount of computing resources (e.g., processor power, memory resources, communication bandwidth, etc.) required (e.g., reduce the use of computing resources at each client, reduce the use of computing resources at the central server, or reduce the overall use of computing resources in the FL system). For example, client partitioning may be useful in implementations where there is a very large number of clients (e.g., thousands or tens of thousands of clients), or where some (or all) clients have limiting computing resources (e.g., low processing power or low memory resources).

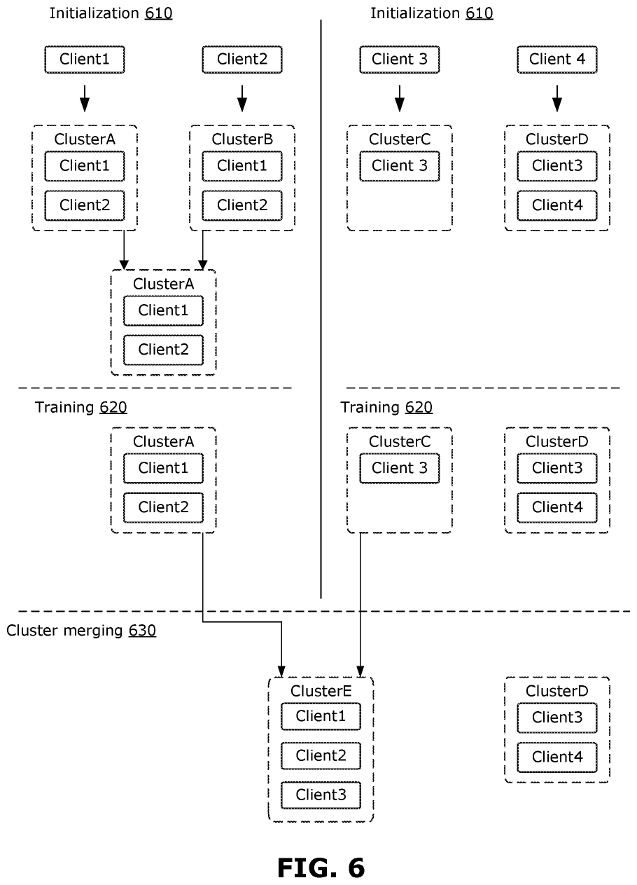

FIG. 6 illustrates an example implementation of the methods described above, with client partitioning into client groups. Similar to the example of FIG. 5, there are four clients (namely Client1, Client2, Client3 and Client4) in this example FL system. It should be understood that in real-world implementation, there may be a much larger number of clients (e.g., hundreds or thousands of clients, or more) in the FL system.

In this example, the four clients are partitioned into two client groups. Client partitioning may be performed prior to the initialization phase. Then the initialization phase 610 is carried out in each client group (e.g., using the methods 300 and 350). In this example, following initialization, one client group has only one cluster, namely ClusterA={Client1, Client2}; while the other client group has two clusters, namely ClusterC={Client3} and ClusterD={Client3, Client4}.

Following initialization, each client group carries out the training phase 620 (e.g., using the methods 400 and 450). The training phase 620 may include cluster merging, but only clusters belonging to the same client group may be merged. Thus, compared to the example of FIG. 5, in the example of FIG. 6 ClusterA and ClusterC are not merged by the completion of the training phase 620 because ClusterA and ClusterC belong to two different client groups. Following completion of the training phase 620 in each of the two client groups, the client partitioning may be removed (i.e., the clients are no longer partitioned into separate client groups) and a further cluster merging phase 630 is carried out.

The cluster merging phase 630 may be carried out using the previously described cluster merging operations (e.g., using steps 406-418 of method 400; and steps 458-470 of method 450). Notably, this cluster merging phase 630 allows merging of clusters belonging to different client groups. In the example of FIG. 6, ClusterA and ClusterC are merged and replaced with ClusterE that is a union of ClusterA and ClusterC. In some examples, further training (e.g., using methods 400 and method 450) may be carried out without the client partitioning.

As mentioned previously, client partitioning may be useful to help reduce the use of computing resources. This may be understood by considering the runtime complexity of the overall FL system, represented using big O notation.

Consider an example in which there are m clients in the FL system. In the initialization phase, each client computes the validation loss for m−1 other model parameters (i.e., from the other m−1 clients). This means the runtime is around O(m²). At the end of the initialization phase, there may be O(m) clusters that start intra-cluster training.

In the training phase, cluster merging may be performed, until the number of clusters reach some number g that is the optimal number of clusters. The runtime of each cluster merger determining is O(mm²), where mᵢ is the number of clusters after the i-th merge,

$${m}_{i} \approx \frac{m}{{2}^{i}}$$

and the total runtime until convergence is

$${\sum }_{i}^{log \frac{m}{g}} O ( {m ( \frac{m}{{2}^{i}} )}^{2} ) = O ( {m}^{3} )$$

Thus, without client partitioning the total runtime of the FL system may be a function of the cube of the number of clients. It may be appreciated that where the number of clients is large (e.g., thousands or tens of thousands), the total runtime is very large.

Client partitioning may help to reduce the total runtime. Consider an example where m clients are partitioned into m/k groups with each group containing k clients. In the initialization phase, each client in a client group computes the validation loss for k−1 other model parameters (i.e., form the other k−1 clients in the same client group). Thus, over m/k groups the runtime is

$$O ( \frac{m}{k} * {k}^{2} ) = O ( mk ) .$$

At the end of the initialization phase, each group may end up with O(k) clusters that start intra-cluster training.

During training, cluster merging may be performed until the number of clusters in a client group reaches some number g. The runtime of a cluster merge determination is O(kkᵢ²), where kⁱ is the number of clusters after i-th merge,

$${k}_{i} \approx \frac{k}{{2}^{i}}$$

and the total runtime until convergence is

$${\sum }_{i}^{log \frac{k}{g}} O ( {k ( \frac{k}{{2}^{i}} )}^{2} ) = O ( {k}^{3} )$$

After the training in each client group is completed, the total number of clusters across all the client groups is

$$O ( \frac{m}{k} g ) ,$$

and the total overall runtime is

$${\sum }_{i}^{log \frac{m}{k}} O ( {m ( \frac{mg}{k {2}^{i}} )}^{2} ) = O ( \frac{{m}^{3} {g}^{2}}{{k}^{2}} )$$

It can be found that the total runtime is minimized when k=m^{0.6}. Then the total runtime is

$$O ( mk ) + O ( {k}^{3} ) + O ( {m}^{3} / {k}^{2} ) = O ( {m}^{1.8} )$$

Thus, client partitioning may help to reduce the total runtime of the FL system. This may be useful in implementations where there is a large number of clients. In some examples, the use of client partitioning may require more training iterations because clients in one client group are not able to collaborate with clients in a different client group. As such, in implementations where the number of clients is smaller (e.g., a few hundred clients) and the reduction in total runtime may be less significant, client partitioning may not be used.

The present disclosure has described methods and systems for FL using client clustering (with or without client partitioning). Examples of the present disclosure may be applied to various technical fields. In FL, client clustering helps to group together clients with similar data distributions so that cluster models can be trained on subsets of the data without needing access to all of the data points. This may be useful when data privacy is a concern or when it is not practical to transfer all the data to a centralized location for training, for example. For example, in healthcare it may be important to preserve patient privacy. Examples of the present disclosure may enable learning of machine learning models using medical data from different hospitals without having to disclose or share sensitive patient information.

In another example, IoT devices may produce large amounts of data in IoT applications that can be difficult or impractical to transfer to a centralized location for centralized learning. Instead, IoT devices can be clustered and cluster models can be trained using only a portion of the IoT data, without having to transfer the entire set.

The example embodiments of the methods and systems described herein may be adapted for use in applications other than FL. For example, although the present disclosure describes example embodiments of the methods and systems in the context of FL, the example embodiments discussed herein may be adapted for use in distributed learning of a model in scenarios where data privacy is not a concern.

Examples of the methods and systems of the present disclosure may enable the use of federated learning in various practical applications. For example, applications of federated learning, as disclosed herein, may include learning a model for predictive text, image recognition or personal voice assistant on smartphones. Other applications of the present disclosure include application in the context of autonomous driving (e.g., autonomous vehicles may provide data to learn an up-to-date model related to traffic, construction, or pedestrian behavior, to promote safe driving). Other possible applications include applications in the context of network traffic management, where federated learning may be used to learn a model to manage or shape network traffic, without having to directly access or monitor a user's network data. Another application may be in the context of learning a model for medical diagnosis, without violating the privacy of a patient's medical data. Example embodiments of the present disclosure may also have applications in the context of the internet of things (IoT), in which a user device may be any IoT-capable device (e.g., lamp, fridge, oven, desk, door, window, air conditioner, etc. having IoT capabilities).

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute example embodiments of the methods disclosed herein. The machine-executable instructions may be in the form of code sequences, configuration information, or other data, which, when executed, cause a machine (e.g., a processor or other processing device) to perform steps in a method according to example embodiments of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method performed by a server in a federated learning (FL) system, the server being in communication with a plurality of clients of the FL system, two or more clusters, each having at least one client, being defined in the FL system, the method comprising:
conducting rounds of intra-cluster training with the two or more clusters to learn, for each respective cluster of the two or more clusters, a respective set of cluster parameters for a respective cluster model of the respective cluster;
merging a first cluster of the two or more clusters with a second cluster of the two or more clusters by:
communicating, to each client of the first and second clusters, the respective first and second set of cluster parameters of the first and second clusters;
receiving, from each client of the first and second clusters,
performance indicators based on performance of each respective first and second set of cluster parameters at each client;
determining, from the performance indicators, that at least the first cluster should be merged with the second cluster;
defining a new merged cluster to be a union of the first and second clusters, the new merged cluster replacing at least the first cluster defined in the FL system; and
selecting one of the respective first and second sets of cluster parameters to be the set of cluster parameters for the new merged cluster; and
conducting at least one round of intra-cluster training with the new merged cluster.

2. The method of claim 1, further comprising:
determining, from the performance indicators, that the second cluster should be merged with the first cluster;
wherein the new merged cluster also replaces the second cluster defined in the FL system.

3. The method of claim 1, wherein the performance indicators received from each client of the first and second clusters are cluster merge decisions indicating whether or not each client agrees with merging the first and second clusters; and
determining that at least the first cluster should be merged with the second cluster includes determining that the cluster merge decisions from all clients of at least the first cluster indicate agreement with merging the first and second clusters.

4. The method of claim 1, wherein the performance indicators received from each client of the first and second clusters are validation losses computed by each client for the respective first and second sets of cluster parameters; and determining that at least the first cluster should be merged with the second cluster includes determining that the validation losses computed for the first set of cluster parameters are not statistically better than the validation losses computed for the second set of cluster parameters across all clients of at least the first cluster.

5. The method of claim 4, wherein the one of the respective first and second sets of cluster parameters selected to be the set of cluster parameters for the new merged cluster is the set of cluster parameters having better validation losses over a majority of the clients of at least the first cluster.

6. The method of claim 1, further comprising, prior to conducting the rounds of training:
receiving, from the plurality of clients, a respective plurality of cluster definitions defining a respective plurality of clusters, each cluster definition being generated by a respective client and defining a set of one or more clients for a respective cluster;
initializing a respective set of cluster parameters for a respective cluster model of each respective cluster; and
transmitting each respective set of cluster parameters to the set of one or more clients of the respective cluster.

7. The method of claim 6, further comprising:
prior to the initializing, reducing the clusters by reducing any duplicate cluster definitions.

8. The method of claim 1, wherein at least one client of the FL system belongs to two or more clusters.

9. The method of claim 1, further comprising, prior to conducting the rounds of intra-cluster training:
partitioning the plurality of clients into client groups;
wherein each cluster is defined to have only clients belonging to a common client group; and
wherein the merging is performed only for merging clusters having clients belonging to the common client group;
the method further comprising:
after completion of the rounds of intra-cluster training, merging at least two clusters having clients belonging to different client groups.

10. A method performed by a client in a federated learning (FL) system, the client being one of a plurality of clients of the FL system, the client being in communication with a central server, two or more clusters, each having at least one client, being defined in the FL system, the method comprising:
for each of one or more clusters that the client belongs to, conducting rounds of intra-cluster training to learn, for each respective cluster of the one or more clusters, a respective set of cluster parameters for a respective cluster model of the respective cluster;
determining whether to merge at least one current cluster of the one or more clusters with at least one other cluster by:
receiving, from the central server, a set of cluster parameters for a cluster model of the at least one current cluster, and a set of cluster parameters for a cluster model of the at least one other cluster;
determining a performance indicator based on performance of each set of cluster parameters at the client; and
transmitting the performance indicator to the central server, the performance indicator being used by the central server to determine that the at least one current cluster should be merged with the at least one other cluster;
receiving, from the central server, a set of cluster parameters for a cluster model of a new merged cluster that is a union of the at least one current cluster and the at least one other cluster; and
conducting at least one round of intra-cluster training with the new merged cluster.

11. The method of claim 10, wherein determining the performance indicator comprises:
computing a respective validation loss for each of the set of cluster parameters of the at least one current cluster and the set of cluster parameters for the at least one other cluster; and
wherein the computed validation losses are transmitted as the performance indicator to the central server.

12. The method of claim 10, wherein determining the performance indicator comprises:
determining performance of each of the set of cluster parameters of the at least one current cluster and the set of cluster parameters for the at least one other cluster at the client;
determining that the performance of the set of cluster parameters of the at least one current cluster is not statistically better than the performance of the set of cluster parameters for the at least one other cluster; and
determining a cluster merge decision indicating agreement with merging the at least one current cluster and the set of cluster parameters for the at least one other cluster;
wherein the cluster merge decision is transmitted as the performance indicator to the central server.

13. The method of claim 12, wherein determining the performance comprises:
computing a respective validation loss for each of the set of cluster parameters of the at least one current cluster and the set of cluster parameters for the at least one other cluster; and
wherein determining that the performance of the set of cluster parameters of the at least one current cluster is not statistically better than the performance of the set of cluster parameters for the at least one other cluster includes determining that the validation loss computed for the set of cluster parameters of the at least one current cluster is not statistically better than the validation loss computed for the set of cluster parameters of the at least one other cluster.

14. The method of claim 10, further comprising, prior to conducting the rounds of training:
training a local model to learn local parameters;
receiving a plurality of sets of model parameters, each set of model parameters corresponding to a local model learned by a respective other client of the plurality of clients;
comparing performance of the learned local parameters with performance of each received set of model parameters;
generating a cluster definition that includes the client as well as each other client having a set of model parameters with equal or better performance compared to the learned local parameters; and
transmitting the cluster definition to the central server.

15. The method of claim 14, further comprising, after transmitting the cluster definition to the central server:
receiving from the central server a respective set of initial cluster parameters for each of the one or more clusters that the client belongs to.

16. The method of claim 10, wherein the client belongs to two or more clusters.

17. A server in a federated learning (FL) system, the server being in communication with a plurality of clients of the FL system, two or more clusters, each having at least one client, being defined in the FL system, the server comprising:
a memory; and
a processing unit in communication with the memory, the processing unit configured to execute instructions in the memory to cause the server to:
conduct rounds of intra-cluster training with the two or more clusters to learn, for each respective cluster of the two or more clusters, a respective set of cluster parameters for a respective cluster model of the respective cluster;
merge a first cluster of the two or more clusters with a second cluster of the two or more clusters by:
communicating, to each client of the first and second clusters, the respective first and second set of cluster parameters of the first and second clusters;
receiving, from each client of the first and second clusters,
performance indicators based on performance of each respective first and second set of cluster parameters at each client;
determining, from the performance indicators, that at least the first cluster should be merged with the second cluster;
defining a new merged cluster to be a union of the first and second clusters, the new merged cluster replacing at least the first cluster defined in the FL system; and
selecting one of the respective first and second sets of cluster parameters to be the set of cluster parameters for the new merged cluster; and
conduct at least one round of intra-cluster training with the new merged cluster.

18. The server of claim 17, wherein the performance indicators received from each client of the first and second clusters are cluster merge decisions indicating whether or not each client agrees with merging the first and second clusters; and
determining that at least the first cluster should be merged with the second cluster includes determining that the cluster merge decisions from all clients of at least the first cluster indicate agreement with merging the first and second clusters.

19. The server of claim 17, wherein the performance indicators received from each client of the first and second clusters are validation losses computed by each client for the respective first and second sets of cluster parameters; and determining that at least the first cluster should be merged with the second cluster includes determining that the validation losses computed for the first set of cluster parameters are not statistically better than the validation losses computed for the second set of cluster parameters across all clients of at least the first cluster.

20. The server of claim 17, wherein the processing unit is configured to execute instructions in the memory to further cause the server to, prior to conducting the rounds of training:
receive, from the plurality of clients, a respective plurality of cluster definitions defining a respective plurality of clusters, each cluster definition being generated by a respective client and defining a set of one or more clients for a respective cluster;
initialize a respective set of cluster parameters for a respective cluster model of each respective cluster; and
transmit each respective set of cluster parameters to the set of one or more clients of the respective cluster.
